(19) United States
(12) Patent Application Publication
(10) Pub. No.: US 2016/0017976 A1
(43) Pub. Date: Jan. 21, 2016

(54) COMPOUND GEAR, METHOD FOR MANUFACTURING THE SAME, IMAGE FORMING APPARATUS, CONSUMABLES, AND IMAGE PROCESSING APPARATUS

(71) Applicant: CANON KABUSHIKI KAISHA, Tokyo (JP)

(72) Inventor: Gaku Iijima, Yokohama-shi (JP)

(21) Appl. No.: 14/801,530

(22) Filed: Jul. 16, 2015

(30) Foreign Application Priority Data
Jul. 18, 2014 (JP) 2014-147663

(51) Int. Cl. F16H 55/17; B29C 45/14

(52) U.S. Cl. CPC F16H 55/17; B29C 45/14311; B29C 45/14336; B29K 2021/003

(57) ABSTRACT

A compound gear including a first member and a second member has grooves between the interface therebetween. The grooves are inclined opposite to the torsion of the teeth so that, when they are released during molding and during rotation, the first member and the second member are not from separated from each other.

### BACKGROUND OF THE INVENTION

1. Field of the Invention

The present invention relates to a method for manufacturing a compound gear having teeth made of a material different from that of a web, an image forming apparatus, consumables, and an image processing apparatus.

2. Description of the Related Art

Resin gears are incorporated as power transmission devices in a wide variety of mechanical products including OA equipment, such as copiers and printers, consumables, such as toner cartridges and ink cartridges, and image processing apparatuses, such as digital cameras and video cameras. Known examples of resin gears serving as high-precision power transmission devices in the related art include helical gears, for which tip sizes and precision standards for meshing errors (JGMA 116-02) and classification of tooth trace (JIS B 1702) are set depending on the application and purpose. Resin gears, in particular, for use in high-quality mechanical products, are often increased in quality by setting the ranges of such precision standards small. Not only high quality but also functional improvement, such as low-noise performance during operation and high printing performance are required for recent color printers and color copiers. The above requirements cannot be satisfied only by the method of setting a small range of gear precision standards described above, and it is necessary to enhance the rotation transmission accuracy (dynamic accuracy) of gears.

To enhance the rotation transmission accuracy of gears, the following solutions are considered: (1) increasing the contact gear ratio; (2) preventing gear rattle; and (3) reducing displacement during rotation. To attain the above solutions, a compound gear made of two or more kinds of material has been invented.

An example is a compound gear including a first member made of resin and having a boss (a shaft supporting portion) fitted to a shaft and a second member made of a material softer than that of the first member and covering the outer circumference of the first member, in which at least a teeth portion is provided around the outer circumference of the second member. Forming the second member with a resin material having higher elasticity than that of a polyacetal resin for use in ordinary gears allows the tooth surfaces to be elastically deformed when the gear is meshed, thus increasing the contact ratio. The high elasticity provides the role of a cushion, thereby reducing the behavior of gear rattle during rotation. That is, the solutions (1) and (2) can be attained more effectively. Furthermore, when the first member is made of a resin material having high rigidity, displacement of the gear during rotation can be reduced, and the effect of solution (3) is not hindered.

However, since rotational torque is exerted on the teeth portion during rotation, a shearing force in the rotational direction is generated at the interface between the first member and the second member. Thus, high rotational torque can cause displacement in the rotational direction, decreasing the rotation transmission accuracy. In insert molding, in particular, in which the first member is placed as an insert member in a mold, and the second member is then injection-molded to form a compound gear, displacement due to coming-off can easily occur because of the low compatibility of the interface. To solve the problems, a compound gear in which grooves and ridges extending in the axial direction are provided around the outer circumference of the first member so that the two members are tightly combined in the rotational direction and a compound gear having protrusions around the outer circumference of the first member have been proposed.

For example, Japanese Patent Laid-Open No. 2008-190681 discloses a technique for increasing the joining strength of the first member and the second member by providing in the axial direction the same or more number of ridges as that of teeth provided on the second member around the outer circumference of the first member made of a metal material.

For example, Japanese Patent Laid-Open No. 2011-220463 discloses a technique of providing a protruding stop member around the outer circumference of a bush made of an inorganic fiber resin, around which a tooth portion made of an organic fiber containing resin is formed.

However, the shearing force is generated at the interface between the first member and the second member not only during the rotation. A composite gear is generally manufactured by inserting a first member into a mold and then injection-molding a second member. The shearing force is generated at the interface when the molded composite gear is released from the mold. As shown in FIG. 8, when the molded object is ejected using an ejecting force E, the gear is released while sliding along the gear tooth traces, generating a shearing force Se in the direction of tooth traces at the interface. Thus, in the case where the ejecting force E is large or the mold release resistance is high, releasing displacement q can occur in the direction of tooth traces. The mold release resistance of a resin gear is considered to be generally about 100 N. Resin gears are generally used under the operation environment within a torque from 0.5 to 10 N·m. Although the shearing force Se in the rotational direction varies with situation, a momentary shearing force Se at the interface may be 10 to 100 times larger during releasing. The shearing force Se generated at the interface during releasing varies significantly depending on the helical angle and the facewidth of the gear. For example, for a compound gear 60 shown in FIG. 8, the mold release resistance of the tooth surfaces increases in proportion to the facewidth t, so that the shearing force Se also increases in proportion. The mold release resistance of the tooth surfaces increases, and the shearing force Se increases as the helical angle β increases.

The gear disclosed in Japanese Patent Laid-Open No. 2008-190681 has, in the axial direction, the same number or more of ridges as that of teeth provided on the second member around the outer circumference of the first member, thereby increasing the joining strength of the first member to the second member. However, this technique focuses attention only on the shearing force during rotation and does not deal with the shearing force generated during releasing.

Japanese Patent Laid-Open No. 2011-220463 discloses a technique of providing a protruding stop member around the outer circumference of a bush made of an inorganic fiber resin, around which teeth made of an organic fiber containing resin are formed. However, to form the protrusions on the outer circumference of the bush, a complicated mold having a plurality of slides has to be used, or secondary processing has to be performed, thus making it difficult to manufacture a large number of gears at low cost.

### SUMMARY OF THE INVENTION

The present invention provides a compound gear in which displacement caused by coming-off due to mold release resistance during molding can be reduced. Furthermore, the present invention provides a compound gear in which displacement caused by coming-off due to torque during rotation can be reduced. The present invention further provides a low-price compound gear.

A compound gear according to a first aspect of the invention is rotatable about an axis and includes a first member made of resin or metal and a second member formed around an outer circumference of the first member. The second member has teeth around an outer circumference thereof, and the teeth are inclined with respect to the axis. The interface between the first member and the second member has alternate depressions and protrusions inclined opposite from the teeth with respect to the axis. The angle of inclination of the alternate depressions and protrusions with respect to the axis is equal to or larger than the angle of inclination of the teeth with respect to the axis and smaller than 90°.

According to another aspect of the present invention, a method for manufacturing a compound gear rotatable about an axis includes pouring molten resin into a mold to form a second member around an outer circumference of a first member, preparing the first member having grooves around the outer circumference, the grooves being inclined with respect to the axis, and pouring the molten resin onto the grooves to form teeth inclined opposite from the grooves with respect to the axis.

The configuration of a compound gear composed of a first member and a second member according to an embodiment of the present invention can reduce displacement due to coming-off and so on caused by mold release resistance during molding and displacement due to coming-off and so on caused by torque during rotation. The configuration allows the compound gear to be provided at a low price.

Further features of the present invention will become apparent from the following description of exemplary embodiments with reference to the attached drawings.

### BRIEF DESCRIPTION OF THE DRAWINGS

FIG. 1A is a front view of a compound gear according to an embodiment of the present invention.

FIG. 1B is a side view of the compound gear.

FIG. 2 is a side view of a first member according to an embodiment of the present invention.

FIG. 3 is a diagram showing an example an injection mold for molding the first member according to an embodiment of the present invention.

FIG. 4 is a diagram showing an example an injection mold for molding a second member according to an embodiment of the present invention.

FIG. 5 is a diagram illustrating the relationship between teeth and depressions and protrusions according to an embodiment of the present invention.

FIG. 6 is a diagram illustrating a first member in comparative example 3.

FIG. 7 is a diagram illustrating a shearing force and displacement generated during rotation.

FIG. 8 is a diagram illustrating a shearing force and displacement generated during releasing.

### DESCRIPTION OF THE EMBODIMENTS

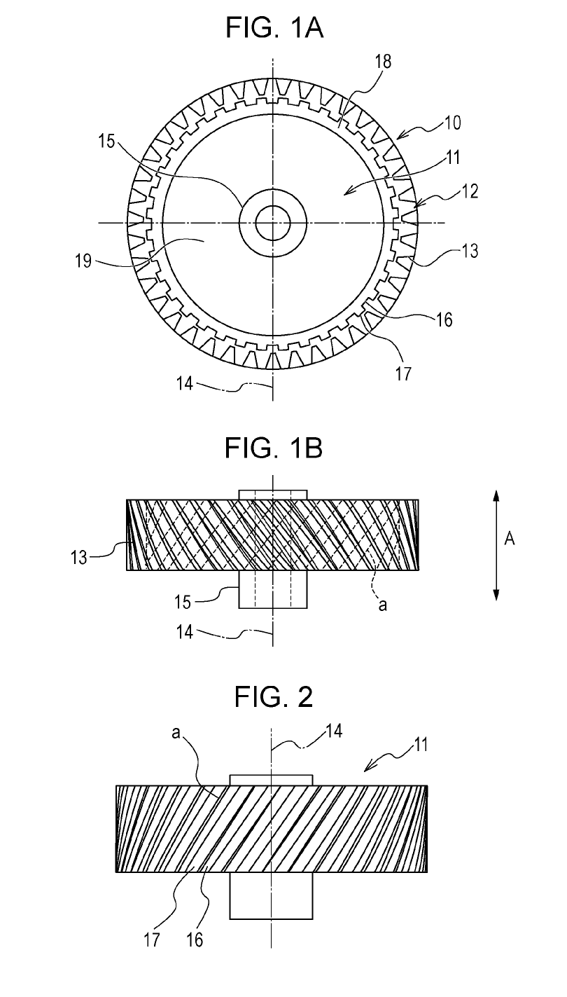

FIGS. 1A and 1B and FIG. 2 are diagrams illustrating the most distinctive features of the present invention. FIG. 1A is a front view of a compound gear 10 according to an embodiment of the present invention. FIG. 1B is a side view of the compound gear 10. The compound gear 10 is composed of a first member 11 and a second member 12 formed around the outer circumference of the first member 11 and having a plurality of oblique teeth 13 (teeth inclined with respect to the axis) around the outer circumference. The compound gear 10 rotates about an axial center 14 or a shaft (not shown) having the axial center 14. That is, the compound gear 10 rotates about an axis. In other words, a shaft (not shown) having the axial center 14 is rotated by rotating the compound gear 10. The first member 11 may include a shaft (not shown) having the axial center 14 or a mounting portion for mounting the first member 11 on a shaft. The first member 11 is manufactured by injection molding with a resin material, such as polyacetal, polybutylene terephthalate, polyphenylene sulfide, polyamide, or nylon, or by cutting, sintering, or pressing with a metal material. The second member 12 is manufactured with a resin material including thermoplastic elastomer. Reference sign 18 denotes the rim of the compound gear 10. The rim 18 is formed around the first member concentrically about the axial center (the central axis) of the compound gear 10. Reference sign 19 denotes a surface constituting the web of the compound gear 10. The web 19 connects the axis mount portion 15 and the rim 18.

FIG. 2 is a side view of the first member 11. Reference sign 16 denotes a groove (a depressed portion) formed around the outer circumference of the first member 11, and 17 denotes a protrusion (a protruding portion) between the groove 16 and the groove 16. The second member 12 (see FIG. 1A) is fitted in the groove 16 to constitute the interface between the first member 11 and the second member 12. In the case of the first member 11, reference sign 16 denotes a depressed portion, and 17 denote a protruding portion, which are alternately and repeatedly disposed around the outermost circumference of the first member 11. For the second member 12, reference sign 16 denotes a protruding portion, and 17 denotes a depressed portion so as to come into contact with the first member 11. Reference sign a denotes a ridgeline that constitutes the portion 16 and the portion 17, or the interface between the first member 11 and the second member 12. The ridgeline a is inclined with respect to the axial direction A of the compound gear 10 and extends in the opposite direction from the oblique teeth 13 in FIG. 1B with respect to the axis.

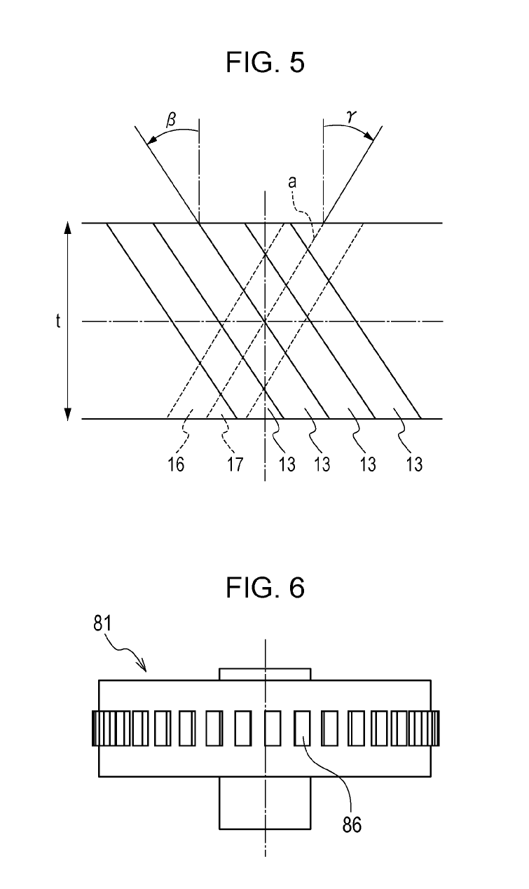

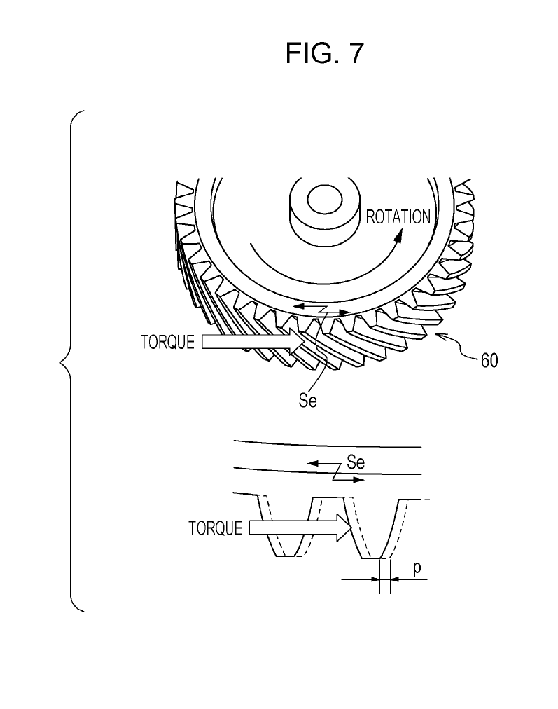

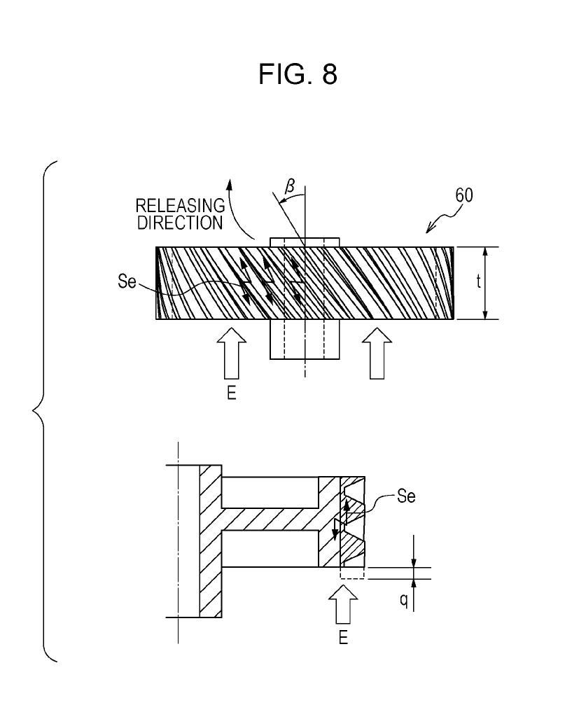

FIG. 5 is a diagram illustrating the relationship between the teeth and the depressions and protrusions of the interface between the first member 11 and the second member 12 in an embodiment of the present invention. Reference sign β denotes the angle of inclination (torsion) of the oblique teeth 13 formed around the outer circumference of the second member 12 with respect to the axis (the axial direction A). Specifically, the angle of inclination (torsion) of the oblique teeth 13 with respect to the axis is an angle formed between the axis and a tangent to the tooth 13 (the borderline of the tooth 13) at a point at which a cross section passing through the center (a central portion) of the width t of the tooth 13 and perpendicular to the axis and the tooth 13 intersect. Reference sign γ denotes the angle of inclination of the ridgeline a that constitutes the depressed portion 16 and the protruding portion 17 of the first member with respect to the axis (the axial direction A). Specifically, γ is an angle formed between the axis and a tangent to the ridgeline a at a point at which a cross section passing through the center (a central portion) of the width t of the tooth 13 in the axial direction A and perpendicular to the axis and the ridgeline a intersect. In the case of the compound gear 10 of this embodiment, the ridgeline a is inclined in the opposite direction from the teeth 14 with respect to the axis (the axial direction A). The angle γ may be equal to or larger than the angle β and smaller than 90°. This is because if the angle γ is equal to or larger than the angle β, displacement due to a shearing force during releasing from the mold can be suppressed. If the angle γ is 90° or more, the ridgeline a will be inclined in the same direction as that of the teeth 14 with respect to the axis. Thus, the shearing force in the tooth trace direction will likely to cause coming-off and large displacement.

Reference sign t denotes the width (facewidth) of the oblique teeth 13 in the axial direction, and m denotes a tooth module. Values t and m may be set to any value. Any value offers the advantageous effects of the present invention; however, the frictional resistance increases as the helical angle β increases, and the surface area of the teeth 13 increases to increase the mold release resistance as the facewidth t increases, so that the displacement q increases. That is, when the angle β is 10° or less, the displacement q is small from the outset. Also when the tooth module m and the facewidth t has a relation m/t>0.2, the displacement q is small. Thus, when the angle of inclination β of the tooth 13 to the axis is larger than 10°, and the relation between the tooth module m and the facewidth t is m/t≦0.2, the advantageous effects of the present invention are brought to the fore.

With the above configuration in which the grooves 16 of the first member 11 having inclination along the interface between the first member 11 and the second member 12 are formed across the entire facewidth in the axial direction, a shearing force in the rotational direction is likely to be received by the sides of the grooves 16, reducing the possibility of coming-off. Furthermore, since the grooves 16 along the interface have inclination, which is opposite to the oblique teeth 13, a shearing force in the tooth traces direction is likely to be received by the sides of the grooves 16, reducing the possibility of coming-off.

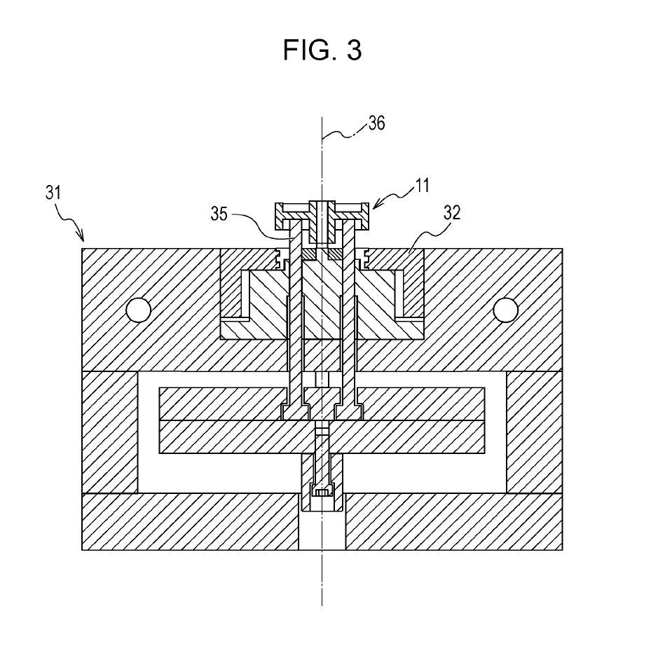

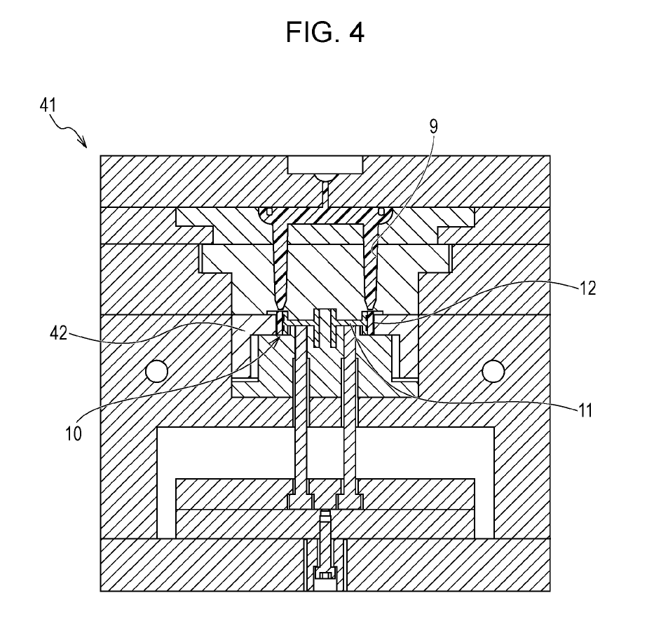

Next, a method for manufacturing the compound gear 10 will be described with reference to FIGS. 3 and 4.

First, the first member 11 is prepared.

FIG. 3 shows an example method for manufacturing the first member 11.

Reference sign 31 denotes a moving part of the mold. Reference sign 32 denotes a dowel rotatable about an axis 36. The dowel 32 has a shape for transferring grooves inclined with respect to the axial direction to the outer circumference of the first member 11. This configuration allows the dowel 32 to rotate along the inclination of the grooves 16 when the first member 11 is ejected with an ejector pin 35, thus allowing the first member 11 to be released from the mold without displacement. The mold having such a rotary dowel has a simpler configuration than that of a mold having a general sliding dowel, and can be smaller in size. This also eliminates the need for forming grooves by cutting or the like. Although a method for manufacturing the first member 11 with molding has been described above, a known method, such as cutting, sintering, or pressing a metal material, may be used. FIG. 4 shows an example method for manufacturing the compound gear 10 by molding the second member 12 in an embodiment of the present invention. For example, the first member 11 molded in FIG. 3 is inserted into a mold 41, and molten resin (for example, thermoplastic elastomer) is poured into a space between a dowel 42 and the first member 11 to mold the second member 12 on the grooves 16 of the first member 11. The material, thermoplastic elastomer, is poured into the space through a sprue runner 9.

When the compound gear 10 is released, since the grooves 16 of the first member 11 having inclination along the interface between the first member 11 and the second member 12 are formed across the entire facewidth in the axial direction, a shearing force in the rotational direction is likely to be received by the sides of the grooves 16, reducing the possibility of coming-off and thus reducing displacement. Furthermore, since the grooves 16 along the interface have inclination, which is opposite to the oblique teeth 13, a shearing force in the tooth traces direction is likely to be received by the sides of the grooves 16, reducing the possibility of coming-off and thus reducing displacement.

Furthermore, allowing the dowel 42 to rotate like the moving mold 31 in FIG. 3 reduces displacement of the second member when the compound gear 10 is released.

As described above, the configuration of the compound gear 10 composed of the first member 11 and the second member 12 of this embodiment can reduce coming-off and displacement due to mold release resistance during molding. The configuration can also reduce coming-off and displacement due to torque during the rotation of the compound gear 10. The configuration allow the compound gear 10 to be provided at low price.

The compound gear according to an embodiment of the present invention is incorporated as a power transmission device in mechanical products including image forming apparatuses, such as copiers and printers, consumables, such as toner cartridges and ink cartridges, and image processing apparatuses, such as digital cameras and video cameras. Since the compound gear according to an embodiment of the present invention has remarkably high rotation transmission accuracy (dynamic accuracy), it offers remarkable functional advantageous effects, such as low noise operation and high printing performance when used in mechanical products, such as image forming apparatuses, consumables, and image processing apparatuses.

Next, examples will be described.

### EXAMPLES

A first member was formed using a mold as shown in FIG. 3, and the first member inserted into a mold as shown in FIG. 4 to mold a second member.

The material of the first member was polyacetal resin (Tenac® HC750, produced by Asahi Kasei Chemicals Corporation). The material of the second member was polyester elastomer (Hytrel® 5557 manufactured by Du Pont-Toray Co. Ltd).

A compound gear with a module m=0.7, a pressure angle of 20°, the number of teeth 32, and a facewidth t=10 mm was manufactured. A displacement p in the rotational direction when the of the manufactured compound gear is rotated at an rpm of 45 and a torque of 1.0 (N·m) and a displacement q in the tooth trace direction when it is released from the mold were measured. The displacements p and q were measured using a laser displacement meter. The displacement p was calculated by photographing an end of the teeth from above using a high-resolution, high-speed camera and analyzing the moving image. The displacement q was calculated by dynamically measuring the displacements of the first member and the second member with two laser displacement meters disposed in the mold.

### Example 1-1

A compound gear having a helical angle β=25° was manufactured with a first member having grooves that are formed around the outer circumference of the first member and have an angle γ=25° inclined with respect to the axial direction and a depth of 0.25 mm, and the displacement p and the displacement q were measured. The results of measurement are shown in Table 1.

### Example 1-2

A compound gear having a helical angle β=25° was manufactured with a first member having grooves that are formed around the outer circumference of the first member and have an angle γ=25° inclined with respect to the axial direction and a depth of 0.5 mm, and the displacement p and the displacement q were measured. The results of measurement are shown in Table 1.

### Comparative Example 1

A compound gear having a helical angle β=25° was manufactured with a first member having no grooves around the outer circumference of the first member, and the displacement p and the displacement q were measured. The results of measurement are shown in Table 1.

### Comparative Example 2

A compound gear having a helical angle β=25° was manufactured with a first member having grooves in the same direction as the axial direction and a depth of 0.5 mm, around the outer circumference of the first member, and the displacement p and the displacement q were measured. The results of measurement are shown in Table 1.

### Comparative Example 3

A compound gear having a helical angle β=25° was manufactured with a first member 81 having protruding portions 86 shown in FIG. 6, and the displacement p and the displacement q were measured. The height of the protruding portion 86 was set to 0.5 mm. The results of measurement are shown in Table 1.

TABLE 1

| | Comparative | Comparative | Comparative | | |
|---|---|---|---|---|---|
| | example 1 | example 2 | example 3 | | |
| | Related art | Related art | Related art | | |
| Conditions | example 1 | example 2 | example 3 | Example 1-1 | Example 1-2 |
| Shape of interface | No groove | Axial | Protrusions | Oblique | Oblique |
| | | depressions | | depressions | depressions |
| | | and protrusions | | and | and |
| | | | | protrusions | protrusions |
| Angle γ (°) | — | 0 | — | 25 | 25 |
| Height of | 0 | 0.5 | 0.5 | 0.25 | 0.5 |
| depressions and | | | | | |
| protrusions (mm) | | | | | |
| Displacement p | 40 | 5 | 8 | 6 | 3 |
| (μm) | | | | | |
| Displacement q | 54 | 49 | 12 | 8 | 5 |
| (μm) | | | | | |

In EXAMPLE 1-1 and EXAMPLE 1-2 in which the groove angle γ is 25° and the helical angle β is 25°, the displacement p and the displacement q can be held below a displacement of 10 μm, which is required for a high-precision gear, providing desired performance.

### Example 2-1

A compound gear having a helical angle β=25° was manufactured with a first member having grooves that are formed around the outer circumference of the first member and have an angle γ=25° inclined with respect to the axial direction and a depth of 0.5 mm, and the displacement q was measured. The result of measurement is shown in Table 2.

### Example 2-2

A compound gear having a helical angle β=25° was manufactured with a first member having grooves that are formed around the outer circumference of the first member and have an angle γ=50° inclined with respect to the axial direction and a depth of 0.5 mm, and the displacement q was measured. The result of measurement is shown in Table 2.

### Example 2-3

A compound gear having a helical angle β=25° was manufactured with a first member having grooves that are formed around the outer circumference of the first member and have an angle γ=70° inclined with respect to the axial direction and a depth of 0.5 mm, and the displacement q was measured. The result of measurement is shown in Table 2.

### Comparative Example 4

A compound gear having a helical angle β=25° was manufactured with a first member having grooves that are formed around the outer circumference of the first member and have an angle γ=10° inclined with respect to the axial direction and a depth of 0.5 mm, and the displacement q was measured. The result of measurement is shown in Table 2.

### Comparative Example 5

A compound gear having a helical angle β=25° was manufactured with a first member having grooves that are formed around the outer circumference of the first member and have an angle γ=15° inclined with respect to the axial direction and a depth of 0.5 mm, and the displacement q was measured. The result of measurement is shown in Table 2.

TABLE 2

| | Comparative | | | | | |
|---|---|---|---|---|---|---|
| | example 2 | | | | | |
| | Related art | Comparative | Comparative | Example | Example | Example |
| Conditions | example 2 | example 4 | example 5 | 2-1 | 2-2 | 2-3 |
| Helical angle β (°) | 25 | 25 | 25 | 25 | 25 | 25 |
| Angle γ (°) | 0 | 10 | 15 | 25 | 50 | 70 |
| Displacement q (μm) | 49 | 40 | 38 | 5 | 4 | 4 |

When the angle γ is in the relation of γ≧β, the displacement q due to a shearing force during releasing can be held below a displacement of 10 μm, which is required for a high-precision gear, thus providing desired performance.

### Example 2-4

A compound gear having a helical angle β=30° was manufactured with a first member having grooves that are formed around the outer circumference of the first member and have an angle γ=35° inclined with respect to the axial direction and a depth of 0.5 mm, and the displacement q was measured. The result of measurement is shown in Table 3.

### Example 2-5

A compound gear having a helical angle β=15° was manufactured with a first member having grooves that are formed around the outer circumference of the first member and have an angle γ=15° inclined with respect to the axial direction and a depth of 0.5 mm, and the displacement q was measured. The result of measurement is shown in Table 3.

### Example 2-6

A compound gear having a helical angle β=15° was manufactured with a first member having grooves that are formed around the outer circumference of the first member and have an angle γ=25° inclined with respect to the axial direction and a depth of 0.5 mm, and the displacement q was measured. The result of measurement is shown in Table 3.

### Comparative Example 6

A compound gear having a helical angle β=30° was manufactured with a first member having grooves that are formed around the outer circumference of the first member and have an angle γ=10° inclined with respect to the axial direction and a depth of 0.5 mm, and the displacement q was measured. The result of measurement is shown in Table 3.

### Comparative Example 7

A compound gear having a helical angle β=30° was manufactured with a first member having grooves that are formed around the outer circumference of the first member and have an angle γ=25° inclined with respect to the axial direction and a depth of 0.5 mm, and the displacement q was measured. The result of measurement is shown in Table 3.

### Comparative Example 8

A compound gear having a helical angle β=15° was manufactured with a first member having grooves that are formed around the outer circumference of the first member and have an angle γ=5° inclined with respect to the axial direction and a depth of 0.5 mm, and the displacement q was measured. The result of measurement is shown in Table 3.

TABLE 3

| | Comparative | Comparative | Comparative | Example | Example | Example |
|---|---|---|---|---|---|---|
| Conditions | example 6 | example 7 | example 8 | 2-4 | 2-5 | 2-6 |
| Helical angle β (°) | 30 | 30 | 15 | 30 | 15 | 15 |
| Angle γ (°) | 10 | 25 | 5 | 35 | 15 | 25 |
| Displacement q (μm) | 41 | 36 | 25 | 8 | 9 | 5 |

The effect of the groove angle γ on the displacement q varies depending on the helical angle β, but if γ≧β, the displacement q due to a shearing force during releasing can be held below a displacement of 10 μm, which is required for a high-precision gear, thus providing desired performance.

### Examples 3-1 and 3-2, Comparative Examples 9 to 12

Table 4 shows comparisons of the displacement q when the helical angle β of a compound gear having a module m=0.7, a pressure angle of 20°, and whose number of teeth is 32 and facewidth t is 10 mm was varied. In COMPARATIVE EXAMPLES 11 and 12, the displacements q are large because the helical angle β is larger than 10°, but in EXAMPLES 3-1 and 3-2 of the present invention, the displacement q could be held within 10 μm by adding grooves (angle γ).

TABLE 4

| | Comparative | Comparative | Comparative | Comparative | Example | Example |
|---|---|---|---|---|---|---|
| Conditions | example 9 | example 10 | example 11 | example 12 | 3-1 | 3-2 |
| Helical angle β (°) | 5 | 10 | 15 | 20 | 15 | 20 |
| Angle γ (°) | 0 | 0 | 0 | 0 | 15 | 20 |
| Displacement q (μm) | 7 | 10 | 34 | 41 | 9 | 8 |

### Examples 3-3 and 3-4, Comparative Examples 13 to 16

Table 5 shows the displacements q when the module m and the facewidth t of a compound gear having a helical angle β=25°, a pressure angle of 20°, and whose number of teeth was 32 were varied. In COMPARATIVE EXAMPLES 14 and 16, the displacements q are large because m/t is less than 0.2, but in EXAMPLES 3-3 and 3-4, the displacements q could be held within 10 μm by adding grooves (angle γ).

TABLE 5

| | Comparative | Comparative | Comparative | Comparative | Example | Example |
|---|---|---|---|---|---|---|
| Conditions | example 13 | example 14 | example 15 | example 16 | 3-3 | 3-4 |
| Module m | 0.5 | 0.5 | 0.7 | 0.7 | 0.5 | 0.7 |
| Facewidth t (mm) | 2 | 5 | 3 | 5 | 5 | 5 |
| m/t | 0.25 | 0.1 | 0.233 | 0.14 | 0.1 | 0.07 |
| Angle γ (°) | 0 | 0 | 0 | 0 | 25 | 25 |
| Displacement q (μm) | 3 | 20 | 5 | 18 | 6 | 7 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-147663, filed Jul. 18, 2014, which is hereby incorporated by reference herein in its entirety.

What is claimed is:

1. A compound gear rotatable about an axis, comprising:
a first member made of resin or metal; and
a second member formed around an outer circumference of the first member,
wherein the second member has a plurality of teeth around an outer circumference thereof, the teeth being inclined with respect to the axis,
wherein an interface between the first member and the second member has alternate depressions and protrusions inclined opposite from the teeth with respect to the axis, and
wherein an angle of inclination of the alternate depressions and protrusions with respect to the axis is equal to or larger than an angle of inclination of the teeth with respect to the axis and smaller than 90°.

2. The compound gear according to claim 1, wherein the angle of inclination of the teeth with respect to the axis is larger than 10°, and a tooth module m and a facewidth t has a relation of m/t≦0.2.

3. The compound gear according to claim 1, wherein a material of the first member includes polyacetal, polybutylene terephthalate, polyphenylene sulfide, polyamide, nylon, and metal.

4. The compound gear according to claim 1, wherein a material of the second member includes thermoplastic elastomer.

5. A method for manufacturing a compound gear rotatable about an axis, the method comprising:
pouring molten resin into a mold to form a second member around an outer circumference of a first member;
preparing the first member having grooves around the outer circumference, the grooves being inclined with respect to the axis; and
pouring the molten resin onto the grooves to form teeth inclined opposite from the grooves with respect to the axis.

6. The method for manufacturing a compound gear according to claim 5, further comprising forming the first member by injection molding.

7. The method for manufacturing a compound gear according to claim 5, further comprising forming the first member by cutting, sintering, or pressing.

8. The method for manufacturing a compound gear according to claim 6, wherein a material of the first member includes polyacetal, polybutylene terephthalate, polyphenylene sulfide, polyamide, and nylon.

9. The method for manufacturing a compound gear according to claim 5, wherein an angle of inclination of the grooves with respect to the axis is equal to or larger than an angle of inclination of the teeth with respect to the axis and smaller than 90°.

10. The method for manufacturing a compound gear according to claim 5, wherein an angle of inclination of the teeth with respect to the axis is larger than 10°, and a tooth module m and a facewidth t has a relation of m/t≦0.2.

11. An image forming apparatus comprising the compound gear according to claim 1.

12. A consumable comprising the compound gear according to claim 1.

13. An image processing apparatus comprising the compound gear according to claim 1.
